(19) United States
(12) Patent Application Publication
(10) Pub. No.: US 2026/0138253 A1
(43) Pub. Date: May 21, 2026

(54) Modular Hammer

(71) Applicant: Dennis Danville, Providence, RI (US)

(72) Inventor: Dennis Danville, Providence, RI (US)

(21) Appl. No.: 19/390,179

(22) Filed: Nov. 14, 2025

Related U.S. Application Data
(60) Provisional application No. 63/722,798, filed on Nov. 20, 2024.

(51) Int. Cl. B25D 1/12; B25D 1/04; B25G 1/01; B25G 3/26

(52) U.S. Cl. CPC B25D 1/12; B25D 1/045; B25G 1/01; B25G 3/26

(57) ABSTRACT

A modular hammer including a head with a head bolt shaft and a handle assembly including a nut assembly hole, a nut and bolt shaft, a shock absorber notch, and a shock absorber. The head is attached to the handle assembly via bolt and a nut is secured to the bolt and positioned within the handle nut and bolt shaft.

### FIELD OF THE INVENTION

The present invention relates to hammers. In particular, the present invention relates to a modularly assembled hammer.

### BACKGROUND

Traditional hand-held hammers can come in the form of one or two-piece hammers. One-piece hammers are made mostly of a single material. Two-piece hammers consist of a separate head and handle. Oftentimes the two-piece hammers are fastened together by glue or other type of adhesive. Because hammers can cause disruptive and sometimes health averse vibrations when used, traditional hammers may have the entire handle made out of a material such as wood. However, traditional two-piece hammers are not designed with stabilizing construction and shock absorption as a main component of their structure. Therefore, there exists a need in the art for a modular hammer with stabilizing and shock absorbing advancements as a key feature. There exists a need in the art for an improved modular hammer as described herein.

### SUMMARY OF THE INVENTION

Embodiments of the present invention are related to a modular hammer including a head with a head bolt shaft. It also may include a handle assembly with a nut assembly hole and a nut and bolt shaft. The head may be attached to the handle assembly via bolt and an assembly nut may be secured to the bolt and positioned within the handle nut and bolt shaft.

The nut assembly hole may be a void structured to allow a manufacturer to hold a nut while tightening a bolt entered from a topside of the head. It may be a semi oval void extending from a flat base that comprises the nut and bolt shaft.

The head may include an L-shaped shelf behind the head front configured to fit the handle assembly therein. There may also be an L-shaped shelf at a claw base structured to fit the handle assembly therein. Furthermore, an upper end of the handle assembly may be positioned between an L-shaped shelf formed behind the head front and an L-shaped shelf formed at the base of the claw.

The nut and bolt shaft may be hexagonal and the handle assembly may include a grip housing secured to a handle core via lower handle bolt.

Another embodiment may include a modular hammer including a head with a head bolt shaft. A handle assembly may include a nut assembly hole, a nut and bolt shaft, a shock absorber notch, and a shock absorber. The head may be attached to the handle assembly via bolt. A nut may be secured to the bolt and positioned within the handle nut and bolt shaft.

In this embodiment, the shock absorber notch may be a tract positioned at an end of the handle assembly proximate the head. The shock absorber may be dimensioned to fit within the shock absorber notch. The shock absorber may include at least one of rubber and plastic. Furthermore, the shock absorber tract may be one of rectangular, square, circular, oval, and polygonal. Likewise, the shock absorber may be one of rectangular, square, circular, oval, and polygonal and dimensioned to fit with the shock absorber tract. The shock absorber may be structured to absorb vibrations from the hammer when used. It may be encased within the handle assembly behind the head when the head and handle assembly are engaged. It may be positioned within the handle assembly and covered by an L-shaped shelf of the head when the head and handle assembly are engaged.

Another embodiment of the invention may include a modular hammer with a handle assembly including a handle housing, a handle core, a pair of opposing side nail pullers, a nut assembly hole, a nut and bolt shaft, a shock absorber notch, and a shock absorber. It may have a head with a head bolt shaft and an L-shaped shelf removably fitted overtop one end of the handle assembly. The head may be attached to the handle assembly via bolt. Furthermore, a nut may be secured to the bolt and positioned within the handle nut and bolt shaft.

In this embodiment, the shock absorber may be positioned within one end of the handle assembly and covered by the L-shaped shelf. Additionally, the handle grip housing may be secured by a lower handle bolt and pressed against a grip housing stopper to prevent prolapsing of the handle grip housing.

### BRIEF DESCRIPTION OF THE DRAWINGS

FIG. 1 is a perspective view of the modular hammer according to an embodiment of the invention.

FIG. 2 is a dissected side view of the modular hammer illustrated in FIG. 1.

FIG. 3 is an exploded perspective view of the modular hammer illustrated in FIG. 1 with exposed interior componentry.

FIG. 4a is a right-side view of the modular hammer illustrated in FIG. 1.

FIG. 4b is a left-side view of the modular hammer illustrated in FIG. 1.

FIG. 5 is a segmented rear view of an upper portion of the modular hammer illustrated in FIG. 1.

FIG. 6 is a bottom interior view of the head of the modular hammer illustrated in FIG. 1.

### DETAILED DESCRIPTION OF THE INVENTION

The present invention will now be described in detail with reference to the accompanying drawings. The embodiment descriptions are illustrative and not intended to be limiting in any way. Other embodiments of the invention will readily suggest themselves to persons with ordinary skill in the art after having the benefit of this disclosure. Accordingly, the following embodiments are set forth without any loss of generality and without imposing limitation upon the claimed invention.

Directional terms such as “above” “below” “upper” “lower” and other like terms are used for the convenience of the reader in reference to the drawings. Additionally, the description may contain terminology to convey position, orientation, and direction without departing from the principles of the present invention. Such positional language should be taken in context of the represented drawings.

Quantitative terms such as “generally” “substantially” “mostly” and other like terms are used to mean that the referred object, characteristic, or quality constitutes a majority of the referenced subject. Likewise, use of the terms such as first and second do not necessarily designate a limitation of quantity. Such terms may be used as a method of describing the presence of at least one of the referenced elements or may provide a means of differentiating orientation. The meaning of any term within this description is dependent upon the context within which it is used, and the meaning may be expressly modified.

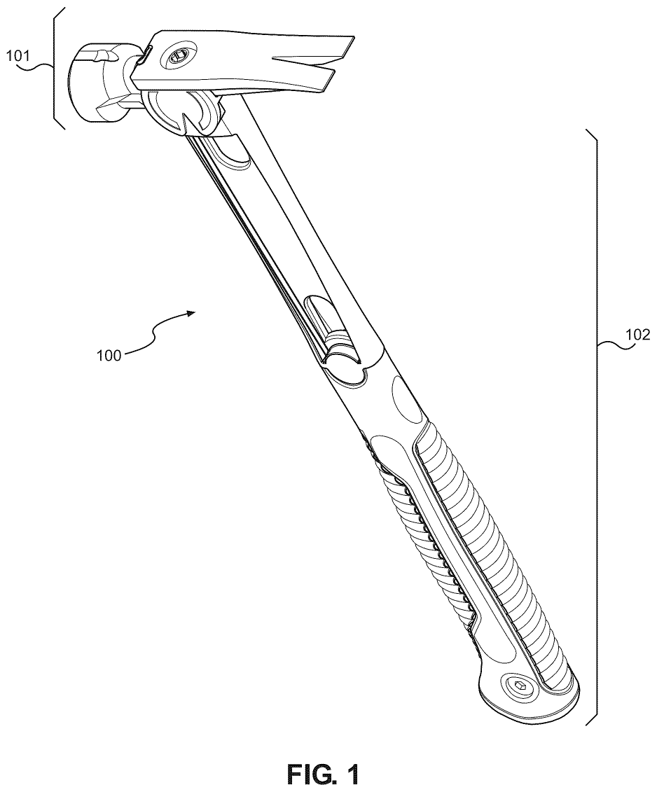

Referring now to FIG. 1, the modular hammer 100, hereinafter referred to as the hammer 100, may include a head 101 and a handle assembly 102 to form a two-piece hammer 100.

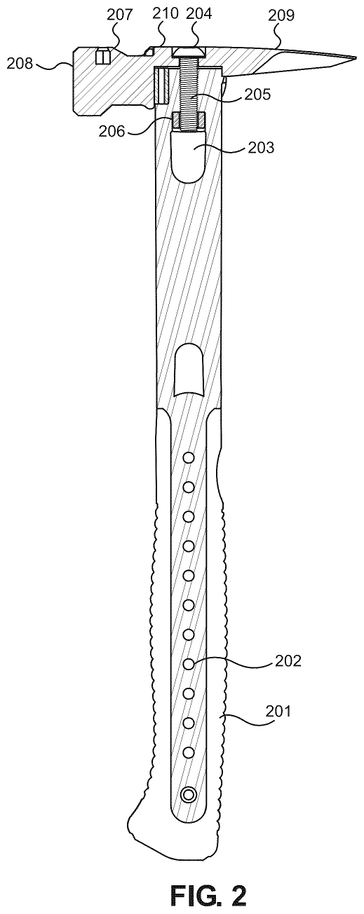

FIG. 2 illustrates a dissected side view of the modular hammer 100 showing some of the interior componentry. As shown, the handle assembly 102 may include a grip housing 201 surrounding and fitting overtop a handle core 202. At the other end of the hammer 100 may be the head 101 including a head front 207 with head face 208, a head top 210, and a head rear 209. An assembly bolt 204 and a head bolt shaft 205 may both permeate through the head top 210. These may align with a handle nut and bolt shaft 302 so that the assembly bolt 204 can be threaded through both. The assembly bolt 204 may be secured via assembly nut 206 positioned and tightened within the nut and bolt shaft 302 so that the head may be attached to the handle assembly 102. In some embodiments, the nut and bolt shaft 302 may be hexagonal.

A nut assembly hole 203 may be a void within the handle structured to allow a manufacturer to hold the assembly nut 206 while tightening the assembly bolt 204 entered from a topside of the head 210. The nut assembly hole 203 may be a semi-oval void extending from a flat base that includes the nut and bolt shaft 302.

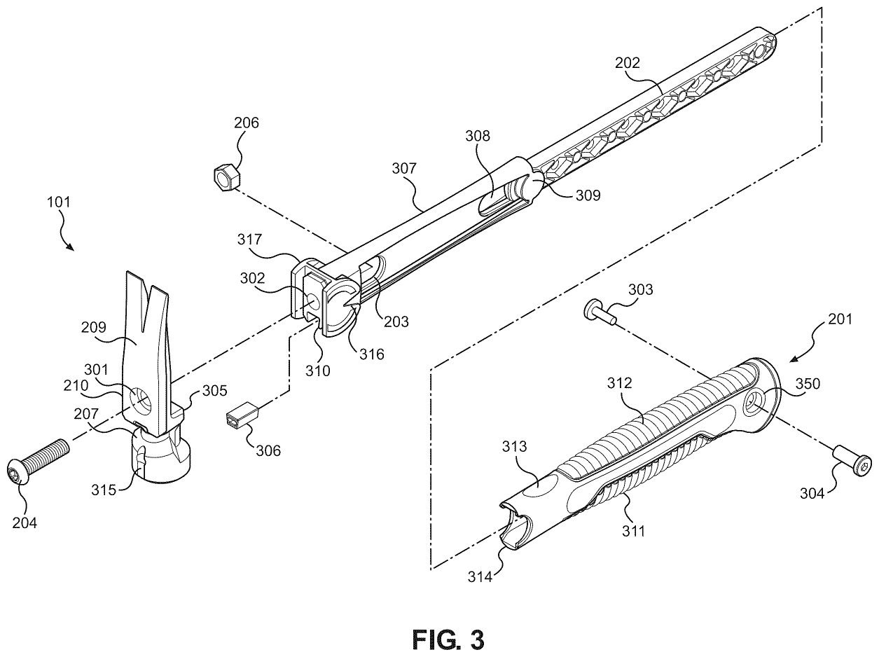

FIG. 3 shows an exploded view of the hammer 100 exposing the interconnectivity of its componentry. As shown, the grip housing 201 may be secured to the handle core 202 via lower handle bolt 303 through a lower housing hole 350 at one side and threading into a bolt sleeve 304 within the lower housing hole 350 from an opposing side. The grip housing 201 may include a palm grip 312, a finger grip 311, and a thumb grip 313 to facilitate a user holding the hammer 100.

Further shown is the handle housing opening 314. As depicted, the handle housing opening 314 may include a lower rounded portion and an upper rounded portion to facilitate a tight fitting overtop the handle core 202. The handle core 202 may fit into a cavity within the grip housing 201 through the handle housing opening 314. The grip housing 201 may then be fitted overtop until the handle housing opening 314 meets with a grip housing stopper 309.

In some embodiments, the grip housing stopper 309 may be located at the base of a lower housing void 308. However, in any embodiment, the grip housing stopper 309 may be located at the base of the upper handle core 307, which may serve as an upper portion of the handle assembly 102.

Once fitted overtop the handle core 202, the handle grip housing 201 may be secured by the lower handle bolt 303 and pressed against the grip housing stopper 309 to prevent prolapsing of the handle grip housing 201. The upper handle core 307 may be structured to resemble an I-beam member used as an intermediary between the handle core 202 and the head 101.

At an opposing end of the upper handle core 307, proximate the head 101, may be the nut assembly hole 203, which may surround the assembly nut 206. The assembly nut 206 may be used to secure the assembly bolt 204 into place. Additionally, the upper handle core 307 may include a pair of opposing side nail pullers 316 found within a pair of opposing nail puller sidings 317. In this embodiment, the nail puller sidings 317 are depicted as rounded with a pie-piece shaped notch removed to form the nail pullers 316.

Proximate the nail puller sidings 317 may be a handle top void 302 used to accommodate the assembly bolt 204 therethrough. Furthermore, at this top end of the handle, a shock absorber notch 310 may be formed to fit a shock absorber 306 therein. As depicted, the shock absorber notch 310 may be a rectangular tract structured to fit a rectangular shock absorber 306 therein. However, one skilled in the art will appreciate that the shock absorber 306 and its respective shock absorber notch 310 may be any shape and dimension including square, circular, round, oval, polygonal, and the like.

The shock absorber 310 may be made of rubber, plastic, a combination of the two, or similar absorbent material and may be used to absorb the vibrations caused by wielding the hammer thereby protecting the user from injury and discomfort. In this embodiment, the shock absorber 306 and shock absorber notch 305 are positioned at an end of the handle assembly proximate the head 101. The shock absorber 306 may be encased within the handle assembly 102 behind the head 209 when the head 101 and handle assembly 102 are engaged. In other words, it may be positioned within the handle assembly 102 and covered by an L-shaped shelf FIGS. 3, 305 of the head 101 when the head 101 and handle assembly 102 are engaged.

As shown in FIG. 3, each side nail puller siding may extend distally from the handle and may include a straight edge to form a space dimensioned to fit the under portion of the head 101 therein. A portion of the underside of the head 101 behind the head front 207 may form an L-shaped fitting or L-shaped shelf 305, to snugly fit the head 101 into the space between the nail puller sidings 317 as well as fit it snuggly parallel with an edge of the handle. This L-shaped shelf 305 may be structured to fit one end of the handle assembly 102 therein. This configuration allows the head 101 to geometrically leverage itself against the upper handle core 307.

Additionally, the head 101 may include a magnetic nail starter nest 315 proximate the head front 207. The magnetic nail starter nest 315 may include a nail track and head notch for leveraging a nail. Also included may be a magnet within the track to prevent the nail from prolapsing when a user begins to position the nail into a surface.

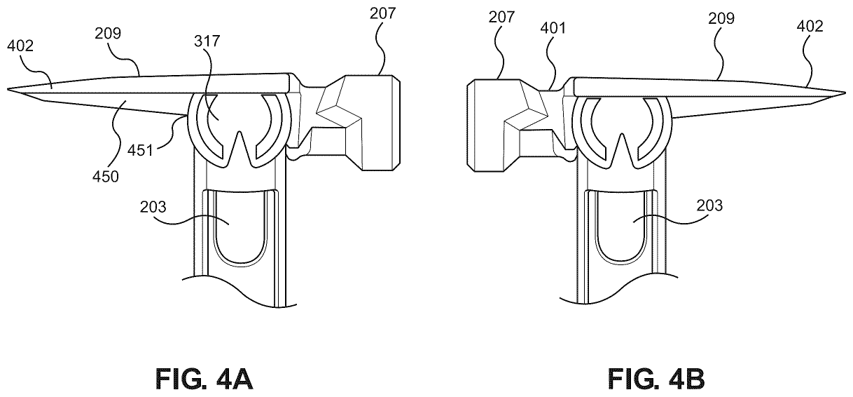

FIGS. 4A and 4B show left and right sides of the head 101 including the nail puller sidings 317, the nut assembly hole 203, the head front and rear 207, 209 and a claw 402 at the head rear 209. Further shown is a medial recess 401 between the head front 207 and head rear 209 forming a transitional portion therebetween. Also shown is that the head 101 may include an L-shaped shelf 450 at a claw base 451 structured to fit the handle assembly 102 therein. In fact, an upper end of the handle assembly 102 may be structured to fit between the L-shaped shelf 305 formed behind the head front 207 and an L-shaped shelf 450 formed at the base of the claw 451.

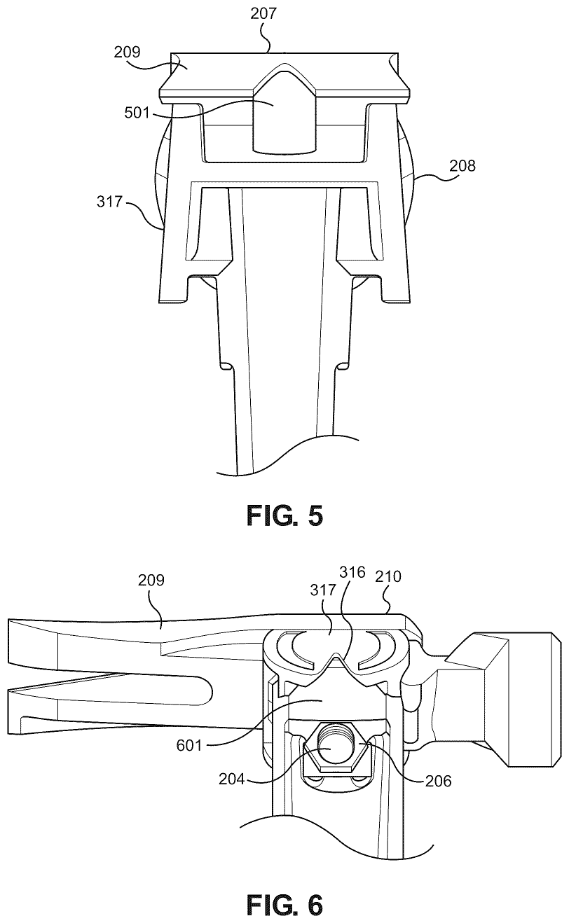

FIG. 5 illustrates an upper back portion of the hammer 100 showing the claw split 501 at the head rear 209. Also shown are the head face 208 as viewed from behind the tool as well as the nail puller siding 317. The head front 207 is depicted for positional awareness opposing the head rear 209.

FIG. 6 shows a bottom interior view of the head 101. It illustrates how the nail puller sides 317 are slightly removed from the rest of the handle forming a side nail puller cavity 601 between the upper handle core 307 and the nail puller sides 317. This allows a user to place a nail head therein to leverage and pry it out. Also shown is the bottom end of the assembly bolt 204 and its encompassing assembly nut 206. Not shown, but what may be understood to a person having ordinary skill in the art, is that the assembly bolt 204 may be further secured into place by additional washers including locking type washers. One skilled in the art will appreciate that the positioning of the washers may be anywhere on the assembly bolt 204 needed to provide a more secure fitting thereof.

In some embodiments the grip housing 201 may encompass 50% or more of the handle assembly 102 and the longitudinal length of the head 101 may measure at least 25% the length of the handle assembly 102.

That which is claimed is:

1. A modular hammer comprising
a head comprising
a head bolt shaft,
a handle assembly comprising
a nut assembly hole,
a nut and bolt shaft,
wherein the head is attached to the handle assembly via bolt;
wherein an assembly nut is secured to the bolt and positioned within the handle nut and bolt shaft.

2. The modular hammer of claim 1 wherein the nut assembly hole is a void configured to allow a manufacturer to hold a nut while tightening a bolt entered from a topside of the head.

3. The modular hammer of claim 1 wherein the nut assembly hole is a semi oval void extending from a flat base that comprises the nut and bolt shaft.

4. The modular hammer of claim 1 wherein the head comprises an L-shaped shelf behind the head front configured to fit the handle assembly therein.

5. The modular hammer of claim 1 wherein the head comprises an L-shaped shelf at a claw base configured to fit the handle assembly therein.

6. The modular hammer of claim 1 wherein an upper end of the handle assembly is positioned between an L-Shaped Shelf formed behind the head front and an L-shaped shelf formed at the base of the claw.

7. The modular hammer of claim 1 wherein the nut and bolt shaft is hexagonal.

8. The modular hammer of claim 1 wherein the handle assembly comprises a grip housing secured to a handle core via lower handle bolt.

9. A modular hammer comprising
a head comprising
a head bolt shaft,
a handle assembly comprising
a nut assembly hole,
a nut and bolt shaft,
a shock absorber notch, and
a shock absorber,
wherein the head is attached to the handle assembly via bolt;
wherein a nut is secured to the bolt and positioned within the handle nut and bolt shaft.

10. The modular hammer of claim 9 wherein the shock absorber notch is a tract positioned at an end of the handle assembly proximate the head.

11. The modular hammer of claim 9 wherein the shock absorber is dimensioned to fit within the shock absorber notch.

12. The modular hammer of claim 9 wherein the shock absorber is comprised of at least one of rubber and plastic.

13. The modular hammer of claim 9 wherein the shock absorber tract is one of rectangular, square, circular, oval, and polygonal.

14. The modular hammer of claim 9 wherein the shock absorber is one of rectangular, square, circular, oval, and polygonal and dimensioned to fit with the shock absorber tract.

15. The modular hammer of claim 9 wherein the shock absorber is configured to absorb vibrations from the hammer when used.

16. The modular hammer of claim 9 wherein the shock absorber is encased within the handle assembly behind the head when the head and handle assembly are engaged.

17. The modular hammer of claim 9 wherein the shock absorber is positioned within the handle assembly and covered by an L-shaped shelf of the head when the head and handle assembly are engaged.

18. A modular hammer comprising
a handle assembly comprising
a handle housing,
a handle core,
a pair of opposing side nail pullers,
a nut assembly hole,
a nut and bolt shaft,
a shock absorber notch, and
a shock absorber
a head comprising
a head bolt shaft,
an L-shaped shelf removably fitted overtop one end of the handle assembly,
wherein the head is attached to the handle assembly via bolt;
wherein a nut is secured to the bolt and positioned within the handle nut and bolt shaft.

19. The modular hammer of claim 18 wherein the shock absorber is positioned within one end of the handle assembly and covered by the L-shaped shelf.

20. The modular hammer of claim 18 wherein the handle grip housing is secured by a lower handle bolt and pressed against a grip housing stopper to prevent prolapsing of the handle grip housing.
